(19) United States
(12) Patent Application Publication
(10) Pub. No.: US 2007/0225017 A1
(43) Pub. Date: Sep. 27, 2007

(54) Method and apparatus for providing geographical location information associated with mobile instant messaging user

(75) Inventors: Ke Qin Li, Beijing (CN); Jun Tao Ma, Beijing (CN); Peng Zhang, Beijing (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/410,981

(22) Filed: Apr. 26, 2006

(30) Foreign Application Priority Data
Mar. 24, 2006 (CN) 200610067662.6

(51) Int. Cl. H04Q 7/20

(52) U.S. Cl. 455/456.1; 709/223; 709/206; 455/446

(57) ABSTRACT

An instant messaging user may request geographical location information associated with another instant messaging user from an instant messaging server. The instant messaging user may receive the geographical location information associated with the mobile instant messaging user from the instant messaging server in an instant message or as presence information. The geographical location information may be obtained from a wireless location device in a wireless network.

### PRIORITY STATEMENT

This non-provisional U.S. patent application claims priority under 35 U.S.C. § 119 to Chinese Patent Application No. ______, filed on ______, the entire contents of which are incorporated herein by reference.

### BACKGROUND OF THE INVENTION

Instant messaging (IM) has become a popular and convenient way for users to communicate instantaneously with many kinds of terminals such as personal digital assistants (PDA), personal computers (PC), mobile phones, smart phones and other such devices (hereinafter referred to as an “IM terminal”). IM communications may involve an instantaneous communication between two users. Each IM user involved in the communication may transmit, receive and display communicated information. IM communications may also involve the display of online presence information regarding other selected users.

IM users may use IM terminals equipped with an IM client to send and receive instant messages. The IM client may include hardware components and software components, and may be capable of establishing, for example, peer-to-peer communications. For example, the IM client may be in the form of a software application loaded on the IM terminal. For purposes of simplicity, the IM client and the IM terminal will be collectively referred to herein as an IM client device. Examples of IM client devices are personal computers, personal digital assistants (PDA), mobile phones or smart phones equipped with software for performing desired instant messaging operations.

IM users may communicate with each other via one or more instant messaging (IM) servers and one or more delivery networks such as the Internet. The IM servers and delivery networks provide direct and/or indirect communication irrespective of physical separation.

The IM servers may function to deal with instant messaging login/logoff operations, indicate an IM user's presence on the instant messaging network and receive and forward instant messages between the IM users as described above. IM servers may provide the IM user's presence information through what is conventionally known as a presence feature. Presence information may be classified into three categories: (1) client status; (2) user status; and (3) extended presence information. Presence information associated with each user may be stored, for example, in a database at the IM server.

Client status may include presence attributes describing, for example, the availability, location and/or capabilities of IM clients and/or IM client devices. User status may include presence attributes describing, for example, the availability of the IM user for communication, personal IM user status, etc. Extended presence information may be vendor specific or service provider non-standard presence attributes, which may be defined dynamically by the service provider. Any or all of the presence features may be stored in a user profile at the IM server.

A contact or buddy list (hereinafter referred to as a contact list) is a user maintained list of IM users stored in the IM system (e.g., at one or more IM servers). The contact list is used for various purposes, such as, a distribution list when sending instant messages or presence information. IM users may manage multiple contact lists for various purposes, such as, a list of friends, list of colleagues, list of business associates, etc. The management of contact lists includes features to create, delete and edit contact lists as well as the ability to obtain a list of contact lists. These features are well-known in the art. Users may also modify the contents of a contact list and retrieve the contents of a contact list from the IM server.

For example, a first IM user is able to obtain (or subscribe to) presence information associated with a second IM user by simply entering the identity (e.g., the username, etc.) of the second IM user into their contact list. The second IM user may approve or deny authorization of some or all presence information stored at the IM server. If approved, the first IM user will receive initial presence information (e.g., the presence information associated with the second IM user currently stored at the IM server) and will also receive new presence information each time the presence information associated with the second IM user is updated. If denied, the first IM user may be notified of the denial by the second IM user, and will not receive the requested presence information. If the first IM user no longer desires to receive the presence information or the updates, the first IM user can unsubscribe to the presence information, and presence information associated with the second IM user may no longer be delivered to the first IM user. The first IM user may unsubscribe from the presence information associated with the second IM user, for example, by removing the second IM user from his/her contact list.

According to the conventional art, presence information regarding an IM user's geographical location or position must be provided by the IM users themselves. However, this may become a

the IM user providing the presence information does not know his/her location and/or if the location of the IM user is constantly changing as in the case of a mobile IM user. Thus, a need exists for a more efficient way to obtain geographic location information of IM users, and provide this geographic location information along with the conventional presence information to users subscribing IM users.

### SUMMARY OF THE INVENTION

Example embodiments of the present invention relate to methods of providing geographical location information along with conventional presence information. This may enable IM users to subscribe and/or acquire geographical location information of other IM users. The geographical location information may be presented in a plurality of ways, such as, graphically in a map, and/or longitude and latitude.

According to an example embodiment of the present invention, geographical location information associated with a mobile instant messaging user may be requested from an instant messaging server. The requested geographical location information associated with the mobile instant messaging user may be received from the instant messaging server. The geographical location information being obtained from a wireless network.

According to another example embodiment of the present a request for geographical location information associated with a mobile instant messaging user may be received and forwarded to the mobile instant messaging user. A determination whether to retrieve geographical location information associated with the mobile instant messaging user may be made based on a first instant message received from the mobile instant messaging user in response to the forwarded request.

According to another example embodiment of the present invention, geographical location information associated with a mobile instant messaging user may be acquired from at least one of a wireless location device and a map server. The acquired geographical location information may be transmitted to an instant messaging user in the form of presence information or via an instant message.

In at least some example embodiments of the present invention, the geographical location information may include a map and/or a geographical position of the mobile instant messaging user. The map may show the geographical position of the mobile instant messaging user and an area surrounding the mobile instant messaging user. The geographical position may include at least a longitude and latitude. The geographical location information may be transmitted and/or received via an instant message and/or in the form of presence information. The request for geographical location information may be forwarded via an instant message.

According to at least some example embodiments of the present invention, a second instant messaging indicating that geographical location information associated with the mobile instant messaging user is unavailable may be transmitted if the first instant message indicates that the mobile instant messaging user has denied the forwarded request.

In at least some example embodiments of the present invention, geographical location information associated with the mobile instant messaging user may be acquired if the first instant message indicates that the mobile instant messaging user has approved the request. At least a portion of the geographical location information may be retrieved from a wireless location device. According to at least some example embodiments of the present invention, a geographical position of the mobile instant messaging user may be obtained from a wireless location device associated with the mobile instant messaging user. The geographical position of the mobile instant messaging user may be obtained from the wireless location device using a mobile unit identifier associated with the mobile instant messaging user. A map illustrating the geographical position of the mobile instant messaging user and area surrounding the geographical position may be obtained from a map server.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an instant messaging (IM) system according to an example embodiment of the present invention;

FIG. 2 is a flow chart illustrating a method for providing geographical location information according to an example embodiment of the present invention; and

FIG. 3 is a flow chart illustrating a method for obtaining geographical location information according to an example embodiment of the present invention.

### DETAILED DESCRIPTION OF EXAMPLE EMBODIMENTS

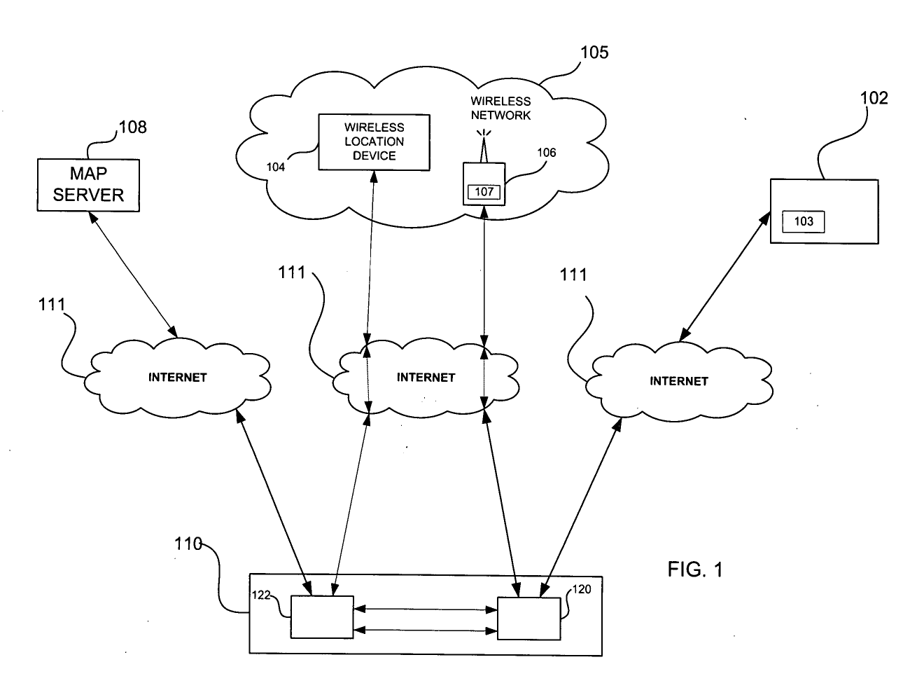

FIG. 1 shows an IM system according to an example embodiment of the present invention. As shown, the instant messaging (IM) user 102 may use an IM client device 103 to send and receive instant messages. The IM client device 103 may be an IM terminal such as a personal computer (PC), a personal digital assistant (PDA), a mobile phone, a smart phone or any other suitable communication device including hardware components and software components capable of establishing, for example, peer-to-peer communications. For example, the IM client device 103 may be a personal computer equipped with a software application for enabling the client device 103 to initiate IM communications with other IM users or an IM server 110.

The IM user 102 may send instant messages to other IM users, such as, mobile IM user 106 via a communications connection including, for example, Internet 111 (or any other delivery network)

more IM servers 10 providing direct and/or indirect communication irrespective of physical separation. The communications connection may be established using TCP/IP or any other suitable communications protocol. Although only a single IM server is illustrated in FIG. 1, example embodiments of the present invention may include any number of IM servers located at the same, or different, locations.

The IM server 110 may include an IM module 120 and a presence module 122. The IM module 120 may function to deal with instant messaging login/logoff operations, receive and forward instant messages between the instant messaging users as described above, along with other IM functions that are well-known in the art. The IM module 120 may be implemented in the form of hardware or software running on existing hardware at the IM server 110.

The presence module 122 may provide presence feature functionality, and may be implemented in the form of hardware or software running on existing hardware. For example, the IM presence module 122 may function to provide an IM user's presence information to other IM users along with other presence feature functionality as is well-known in the art. IM server, 110 may be located anywhere and may communicate with other IM servers through, for example, the Internet 111 or any other communication network.

Still referring to FIG. 1, mobile IM user 106 may receive instant messages from the IM user 102 via the communications connection including, for example, wireless network 105, the Internet 111 and the IM server 110. As shown, the mobile IM user 106 may use a mobile IM client device 107 to send and receive instant messages. The mobile IM client device 107 may be an IM terminal such as a personal computer (PC), a personal digital assistant (PDA), a mobile phone, a smart phone or any other suitable wireless communication device including hardware components and software components capable of establishing, for example, peer-to-peer communications wirelessly. For example, the mobile IM client device 107 may be a mobile phone equipped with a software application for enabling the mobile IM client device 107 to initiate IM communications with other IM users (e.g., IM user 102) or the IM server 110. The mobile IM user 106 may access the Internet 111 via the wireless network 105. Instead of illustrating all well-known components of the wireless network 105, such as, one or more base transceiver stations (BTS), radio network controllers (RNC), etc., the wireless network 105 is illustrated as a cloud for purposes of clarity. Although IM client device 103 has been described as a personal computer and the mobile IM client device 107 has been described as a mobile phone, the IM client device 103 and the mobile IM client device 107 may be any suitable wireless or terrestrial electronic device having suitable communications capability, for example, any of the IM client devices discussed herein.

Similar to the IM client devices 103 and 106, the wireless location device 104 may be capable of establishing, for example, peer-to-peer communications with at least the IM server 110. An example of a wireless location device 104 is a personal computer or server, including software for performing desired operations. For example, if the wireless network 105 is a GSM network, the wireless location device 104 may be a GSM mobile location center (GMLC). In another example, if the wireless network 105 is a CDMA network, the wireless location device 104 may be a mobile positioning center (MPC). In yet another example, a higher level device such as an intelligent services gateway (ISG) may be used. The conventional functionality and components of each of these is well-known in the art, and thus, a detailed explanation will be omitted for the sake of brevity.

In addition to the conventional components and functionality, the wireless location device 104 may include additional hardware components or a software application loaded thereon for enabling communications initiated by itself or the IM server 10. The wireless location device 104 may communicate with the IM server 110 via the Internet 111. The wireless location device 104 may access the Internet 111 via the wireless network 105.

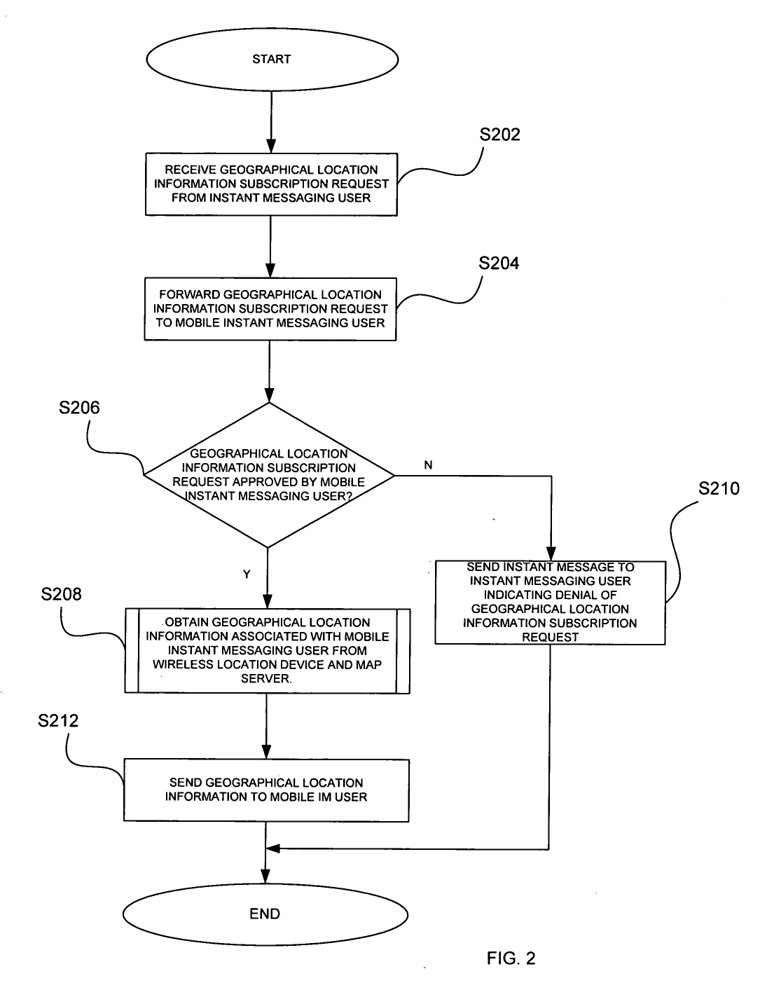

FIG. 2 is a flow chart illustrating a method for providing geographical location information, according to an example embodiment of the present invention. The method shown in FIG. 2 will be described with regard to the IM system shown in FIG. 1 and may be performed at the IM server 10.

Referring to FIG. 2, at step S202 the IM module 120 may receive a presence information subscription request from IM user 102. The IM module 120 may send the subscription request to presence module 122. The subscription request may include a request for geographical location information (or geographical position information) associated with the mobile IM user 106. The subscription request may be triggered when the IM user 102 enters the mobile IM user 106 into his/her contact list at the IM client device 103.

At step S204, the IM server 110 may forward or relay the received subscription request to mobile IM user 106. The received subscription request may be forwarded to the mobile IM user 106, for example, in the form of one or more instant messages. In an example embodiment, the IM server 110 may generate and send an instant message the mobile IM user 106 requesting approval or denial of the subscription request from IM user 102.

At step S206, the IM server 110 may receive an indication as to whether the mobile IM user 106 has approved or denied the subscription request. For example, the mobile IM user 106 may approve or deny the forwarded subscription request by sending an instant message back to the IM server 110. The instant message sent from the mobile IM user 106 to the IM server 110 may indicate whether the mobile IM user 106 will allow the IM server 110 to deliver geographical location information associated with the mobile IM user to IM user 102. Upon receipt of the approval or denial of the subsription request, the IM server 110 may record the status (i.e., the approval or denial) of the subscription request.

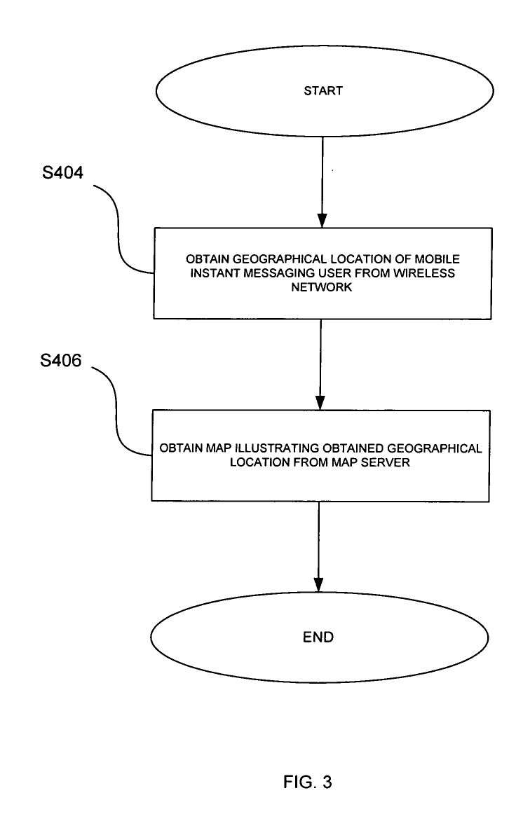

If approved, at step S208, the IM server 110 may obtain the geographical location information associated with the mobile IM user 106 from the wireless location device 104 and a map server 108. This process will be described in greater detail below with respect to FIG. 3. At step S212, the IM server 110 may deliver the obtained geographical location information to the IM user 102. The geographical location information associated with the mobile IM user 106 may include at least latitude and longitude coordinates representing the position or location of the mobile IM user 106, and a map image illustrating the location or position of the mobile IM user 106. The map image may also include the area surrounding the position of the mobile IM user 106 as defined, for example, by a radius in miles, kilometers, etc.

Returning to step S206, if the IM server 110 receives an indication that the subscription request from IM user 102 has been denied, the IM server 110 may send an instant message to the IM user 102 indicating that the subscription request requesting the geographical location information associated with mobile IM user 106 has been denied, at step S210.

As discussed above, if the subscription request from IM user 102 is approved by the mobile IM user 106, the IM server 110 may acquire or obtain geographical location information associated with the mobile IM user 106 from the wireless location device 104 and the map server 108.

FIG. 3 is a flow chart illustrating a method for obtaining geographical location information according to an example embodiment of the present invention. The method of FIG. 3 may be performed at the IM server 110, for example, in response to an approval instant message from the mobile IM user 106. In at least one example embodiment of the present invention, the IM server 110 may obtain a location of the mobile IM user 106 from the wireless location device 104, and subsequently obtain an illustration of the obtained location in the form of a map obtained from the map server 108. The location obtained from the wireless location device 104 may be in the form of latitude and longitude coordinates, and the map image obtained from the map server 108 may be a map image illustrating the location of the mobile IM user 106 along with a specifiable area surrounding the location of the mobile IM user 106.

Referring to FIG. 3, at step S404, the IM server 110 may obtain the geographical location or position of the mobile IM user 106 from the wireless location device 104. As discussed above, the IM server 110 may store information associated with each IM user or client registered therewith. In the case of the mobile IM user 106 accessing IM services using a mobile phone or other wireless communication device, for example, the IM server 110 may store in a user profile for each IM user at least a mobile unit identifier (e.g., a mobile phone number, an electronic serial number (ESN), etc.). The IM server 110 may access the profile for mobile IM user 106 to obtain the mobile unit identifier stored therein.

The IM server 110 may then transmit a mobile location request to the wireless location device 104. This mobile location request may be in the form of an instant message or any other suitable method for communication. The mobile location request may include at least the mobile unit identifier associated with the mobile IM user 106.

After receiving the mobile location request including the mobile unit identifier associated with mobile IM user 106, the wireless location device 104 may send the geographical location of the mobile IM user 106 to the IM server 110. The geographical location or position of the mobile IM user 106 may be identified by at least latitude and longitude coordinates.

Returning to FIG. 3, at step S406, after receiving the geographical position of the mobile IM user 106 from the wireless location device 104, the IM server 110 may obtain a map illustrating the geographical position received from the wireless location device 104.

In at least one example embodiment, to obtain the map, the IM server 110 may establish a connection to an Internet map service or map server 108. The connection may be, for example, a hyper-text-transfer-protocol (HTIP) connection through the Internet 111. The IM server 110 may then send a map request including the received geographical position of the mobile IM user 106 (e.g., the received longitude and latitude coordinates) as a parameter. The map request may also include other parameters such as a desired scale of the map, the desired radius of area surrounding the geographical position of the mobile IM user 106, etc. These parameters may be user defmed, for example, in the subscription request sent from the IM user 102. The map server 108 may then obtain a map image based on the received parameters. The map server 108 may return the map image to the IM server 110 over the established HTTP connection.

The IM server 110 may then send the geographical position of the mobile IM user 106 (e.g., latitude and longitude coordinates) and the obtained map image to the IM user 102. The geographical position of the mobile IM user 106, the obtained map image or the combination thereof may be referred to as geographical location information. The geographical location information may be delivered to the IM user 102 in the form of presence information or in a separate instant message.

Although example embodiments of the present invention have been described with regard to both the geographical location of the mobile IM user 106 and the map image being included in the geographical location information, the geographical location information may include either the geographical location of the mobile IM user 106 or a map image illustrating the geographical location of the mobile user 106.

In example embodiments of the present invention, the geographical location of the mobile IM user 106 is acquired by the IM server 110 from the wireless location device 108, instead of being provided by the mobile IM client. The IM server 110 may also acquire a map image associated with the received geographical location of the mobile IM user 106, which may make the geographic information more user friendly.

According to example embodiments of the present invention, geographical location information and a map image, in addition to plain presence information, may be provided to IM user 102. The IM server 110 may acquire geographical location information of mobile IM user 106 from wireless location device 104, and thus, the mobile IM client 107 need not be equipped with any additional positioning devices; instead the geographic position of the mobile IM user 106 may be provided by existing wireless network components or functionality.

Example embodiments of the present invention have been described with regard to a map server accessed by way of an HTTP connection from the IM server. However, the map server may be any suitable type of server (e.g., a web server, etc.) and may be accessed and/or communicated with using any suitable protocol other than or in combination with HTTP.

The invention being thus described, it will be obvious that the same may be varied in many ways. Such variations are not to be regarded as a departure from the invention, and all such modifications are intended to be included within the scope of the invention.

We claim:

1. A method, comprising:
requesting geographical location information associated with a mobile instant messaging user from an instant messaging server;
receiving the geographical location information associated with the mobile instant messaging user from the instant messaging server, the geographical location information being obtained from a wireless network.

2. The method of claim 1, wherein the geographical location information includes at least a map.

3. The method of claim 2, wherein the geographical location information further includes at least a geographical position of the mobile instant messaging user, and wherein the map shows the geographical position of the mobile instant messaging user and an area surrounding the mobile instant messaging user.

4. The method of claim 3, wherein the geographical position includes at least a longitude and latitude.

5. The method of claim 1, wherein the geographical location information includes a map illustrating a geographical position of the mobile instant messaging user.

6. The method of claim 5, wherein the geographical position includes at least a longitude and latitude.

7. The method of claim 1, wherein the geographical location information is received via an instant message.

8. The method of claim 1, wherein the geographical location information is received in the form of presence information.

9. A method, comprising:
receiving a request for geographical location information associated with a mobile instant messaging user;
forwarding the request for geographical location information to the mobile instant messaging user; and
determining whether to retrieve geographical location information associated with the mobile instant messaging user based on a first instant message received from the mobile instant messaging user in response to the forwarded request.

10. The method of claim 9, wherein the request is forwarded via an instant message.

11. The method of claim 9, further comprising:
transmitting a second instant messaging indicating that geographical location information associated with the mobile instant messaging user is unavailable if the first instant message indicates that the mobile instant messaging user has denied the forwarded request.

12. The method of claim 9, further comprising:
retrieving geographical location information associated with the mobile instant messaging user if the first instant message indicates that the mobile instant messaging user has approved the request.

13. The method of claim 12, wherein at least a portion of the geographical location information is retrieved from a wireless location device.

14. The method of claim 12, wherein the retrieving step further comprises:
obtaining a geographical position of the mobile instant messaging user from a wireless location device associated with the mobile instant messaging user.

15. The method of claim 14, wherein the geographical position of the mobile instant messaging user is obtained from the wireless location device using a mobile unit identifier associated with the mobile instant messaging user.

16. The method of claim 14, wherein the retrieving step further comprises:
obtaining a map illustrating the geographical position and area surrounding the geographical position from a map server.

17. The method of claim 12, further comprising:
transmitting a second instant message including the retrieved geographical location information associated with the mobile instant messaging.

18. The method of claim 12, wherein the retrieved geographical location information is delivered in the form of presence information.

19. The method of claim 13, wherein the geographical position of the mobile instant messaging user includes at least a longitude and latitude.

20. The method of claim 9, wherein the third instant message is indicative of whether the mobile instant messaging user approves or denies the request for geographical location information.

21. A method, comprising:
acquiring geographical location information associated with a mobile instant messaging user from at least one of a wireless location device and a map server; and
transmitting the acquired geographical location information to an instant messaging user in the form of presence information or via an instant message.
